(19) United States
(12) Patent Application Publication
(10) Pub. No.: US 2023/0169388 A1
(43) Pub. Date: Jun. 1, 2023

(54) SYSTEMS AND METHODS FOR TRAINING A MACHINE LEARNING MODEL FOR A SECOND LANGUAGE BASED ON A MACHINE LEARNING MODEL FOR A FIRST LANGUAGE

(71) Applicant: Meta Platforms, Inc., Menlo Park, CA (US)

(72) Inventors: Lin Huang, Menlo Park, CA (US); Ying Zhang, Palo Alto, CA (US)

(21) Appl. No.: 16/016,321

(22) Filed: Jun. 22, 2018

(51) Int. Cl. G06N 99/00; G06F 17/28

(52) U.S. Cl. CPC G06N 99/005; G06F 17/28; G06Q 50/01

(57) ABSTRACT

Systems, methods, and non-transitory computer readable media can train a machine learning model for a first language to determine a classification for a content item in the first language. Machine translation can be performed to generate respective machine translations of a plurality of content items in a second language into the first language. Respective classifications for the plurality of content items in the second language can be determined based on the machine translations of the plurality of content items in the second language and the machine learning model for the first language. Training data in the second language can be automatically generated, where the training data in the second language includes the plurality of content items in the second language and the respective classifications.

### FIELD OF THE INVENTION

The present technology relates to the field of social networks. More particularly, the present technology relates to techniques for training machine learning models associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

### SUMMARY

Various embodiments of the present technology can include systems, methods, and non-transitory computer readable media configured to train a machine learning model for a first language to determine a classification for a content item in the first language. Machine translation can be performed to generate respective machine translations of a plurality of content items in a second language into the first language. Respective classifications for the plurality of content items in the second language can be determined based on the machine translations of the plurality of content items in the second language and the machine learning model for the first language. Training data in the second language can be automatically generated, where the training data in the second language includes the plurality of content items in the second language and the respective classifications.

In some embodiments, training data for the machine learning model for the first language includes a plurality of content items in the first language and respective classifications.

In certain embodiments, the machine learning model for the first language is trained to output a score indicative of a predicted likelihood of the content item in the first language being associated with the classification for the content item in the first language.

In an embodiment, a machine learning model for the second language can be trained based on the training data in the second language to determine a classification for a content item in the second language.

In some embodiments, the machine learning model for the second language is trained to output a score indicative of a predicted likelihood of the content item in the second language being associated with the classification for the content item in the second language.

In certain embodiments, a particular content item in the second language can be obtained, and a classification for the particular content item in the second language can be determined based on the machine learning model for the second language.

In an embodiment, the machine learning model for the second language can be refined based on at least a verified portion of the training data in the second language.

In some embodiments, a classification for a content item is indicative of a particular type of content item.

In certain embodiments, the performing the machine translation includes translating text of a content item of the plurality of content items in the second language from the second language into the first language.

In an embodiment, the training data in the first language and the training data in the second language include features relating to one or more of: content attributes, user attributes, comment attributes, or reaction attributes.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example machine learning internationalization module configured to train a machine learning model for a second language based on a machine learning model for a first language, according to an embodiment of the present technology.

FIG. 2A illustrates an example first language machine learning module configured to train a machine learning model to classify content items in a first language, according to an embodiment of the present technology.

FIG. 2B illustrates an example second language machine learning module configured to train a machine learning model to classify content items in a second language, according to an embodiment of the present technology

FIG. 3 illustrates an example functional block diagram for training a machine learning model for a second language based on a machine learning model for a first language, according to an embodiment of the present technology.

FIG. 4 illustrates an example first method for training a machine learning model for a second language based on a machine learning model for a first language, according to an embodiment of the present technology.

FIG. 5 illustrates an example second method for training a machine learning model for a second language based on a machine learning model for a first language, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Training a Machine Learning Model for a Second Language Based on a Machine Learning Model for a First Language

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

Conventional approaches specifically arising in the realm of computer technology can classify content items based on various attributes. For example, content items can be classified as a particular type of content item. Content items may be in different languages, and conventional approaches can train a separate machine learning model for a particular language to classify content items in that language. For example, a machine learning model for a particular language can be trained based on training data in that language. However, training separate machine learning models for different languages can be inefficient and require a significant amount of resources. In some cases, conventional approaches may train a machine learning model for a first language to classify content items in the first language and apply the trained machine learning model for the first language to machine translations of content items in a second language in order to classify the content items in the second language. However, to support real time operations of a social networking system, an extensive volume of machine translation may need to be performed in real time for numerous content items, which can require a significant amount of computing resources.

An improved approach rooted in computer technology can overcome the foregoing and other disadvantages associated with conventional approaches specifically arising in the realm of computer technology. Based on computer technology, the disclosed technology can train a machine learning model for classifying content items in a second language based on a machine learning model for classifying content items in a first language. For example, the machine learning model for the first language can be trained based on training data in the first language to determine a classification for a content item in the first language. The training data in the first language can include content items in the first language and corresponding labels for classifications. For example, a classification for a content item can be indicative of a particular type of content item. The disclosed technology can generate training data for training the machine learning model for the second language. For example, machine translation can be performed on a content item in the second language, and the machine learning model for the first language can be applied to the machine translation of the content item in the second language in order to determine a classification for the content item in the second language. The content item in the second language and a corresponding label for the classification determined by the machine learning model for the first language can be included in the training data for training the machine learning model for the second language. Accordingly, the training data for the machine learning model for the second language can be generated automatically without manual labeling by humans. The machine learning model for the second language can be trained based on the training data generated in this way to determine a classification for a content item in the second language. In some embodiments, a classification and/or a corresponding label for a content item in the second language determined by the machine learning model for the first language can be manually verified by humans in order to increase accuracy. For example, the machine learning model for the second language can be refined based on content items in the second language and corresponding labels that are verified by humans. In this manner, the machine learning model for the second language can be trained based on automatically generated training data that leverages training of the machine learning model for the first language. Additional details relating to the disclosed technology are provided below.

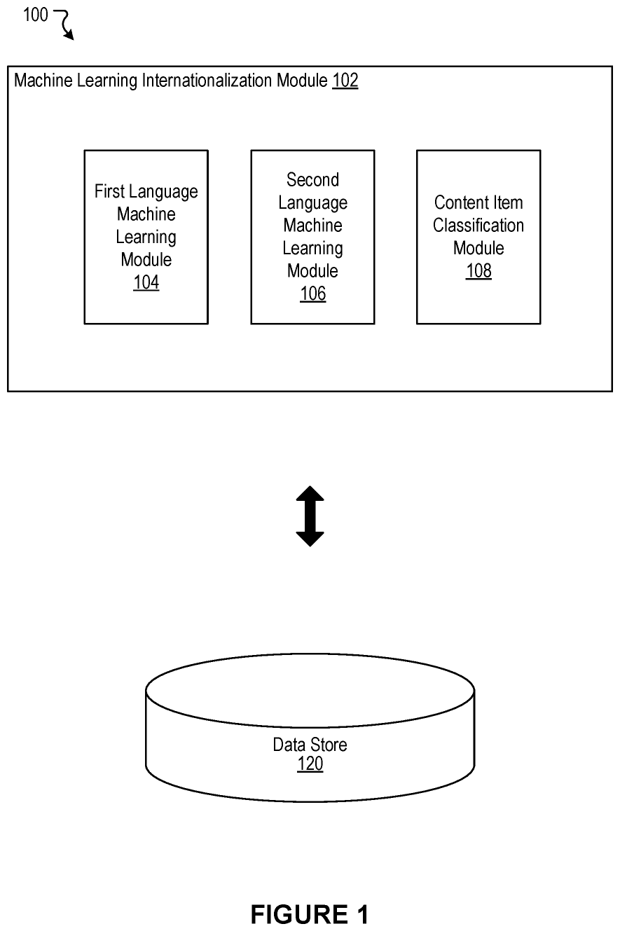

FIG. 1 illustrates an example system 100 including an example machine learning internationalization module 102 configured to train a machine learning model for a second language based on a machine learning model for a first language, according to an embodiment of the present technology. The machine learning internationalization module 102 can train one or more machine learning models to classify content items in different languages. A content item can include any type of content. For example, a content item can include text, an image, a video, audio, a combination thereof, etc. In some embodiments, a content item can be a post associated with a social networking system. A user may create a comment in response to a content item or select a sentiment reaction in response to a content item. A sentiment reaction may also be referred to as a “reaction.” The machine learning internationalization module 102 can train a machine learning model to determine a classification for a content item in a particular language. For example, a classification can be associated with a particular type of content item. Accordingly, the machine learning internationalization module 102 can train machine learning models to classify various types of content items.

The machine learning internationalization module 102 can include a first language machine learning module 104, a second language machine learning module 106, and a content item classification module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the machine learning internationalization module 102 can be implemented in any suitable combinations. While the disclosed technology is described in connection with content items associated with a social networking system for illustrative purposes, the disclosed technology can apply to any other type of system and/or content.

The first language machine learning module 104 can train a machine learning model to classify content items in a first language. For example, the machine learning model can be trained based on training data in the first language. The trained machine learning model can determine a classification for a content item in the first language. Functionality of the first language machine learning module 104 is described in more detail herein.

The second language machine learning module 106 can train a machine learning model to classify content items in a second language. For example, the second language machine learning module 106 can generate training data for training the machine learning model for classifying content items in the second language based on a machine learning model for classifying content items in the first language. Machine translation can be applied to a content item in the second language, and a classification can be determined for the machine translation of the content item in the second language based on the machine learning model for the first language. The content item in the second language and the corresponding classification can be included in the training data for training the machine learning model to classify content items in the second language. Functionality of the second language machine learning module 106 is described in more detail herein.

The content item classification module 108 can determine classifications for content items in different languages. For example, the content item classification module 108 can classify whether a content item in a first language is a particular type of content item based on a machine learning model for the first language. Similarly, the content item classification module 108 can classify whether a content item in a second language is a particular type of content item based on a machine learning model for the second language. The machine learning model for the first language can be trained by the first language machine learning module 104, as discussed herein. The machine learning model for the second language can be trained by the second language machine learning module 106, as discussed herein.

In this way, the machine learning internationalization module 102 can leverage machine learning from the machine learning model for the first language in training the machine learning model for the second language. The machine learning internationalization module 102 can automatically generate training data for training the machine learning model for the second language based on classifications determined by the machine learning model for the first language, which can reduce required time, effort, and computing resources for training the machine learning model for the second language. In this regard, generating the training data for the machine learning model for the second language based on classifications determined by the machine learning model for the first language can facilitate identifying positive training examples as described further below. In addition, leveraging machine learning from the machine learning model for the first language to train a machine learning model for the second language can reduce an amount of machine translation that needs to be performed. In some cases, the machine learning model for the first language can be used to classify both content items in the first language and the second language without training a machine learning model for the second language. For example, machine translation can be applied to content items in the second language in real time, and the machine learning model for the first language can be applied to the machine translations of the content items in the second language in order to classify the content items in the second language. However, this approach can require a significant amount of machine translation to be performed in real time as the content items in the second language are created by users of a social networking system. By using classifications determined by the machine learning model for the first language to generate the training data for the machine learning model for the second language, the machine learning internationalization module 102 can apply machine translation in an offline (or non-real time) manner to only those content items in the second language to be included in the training data.

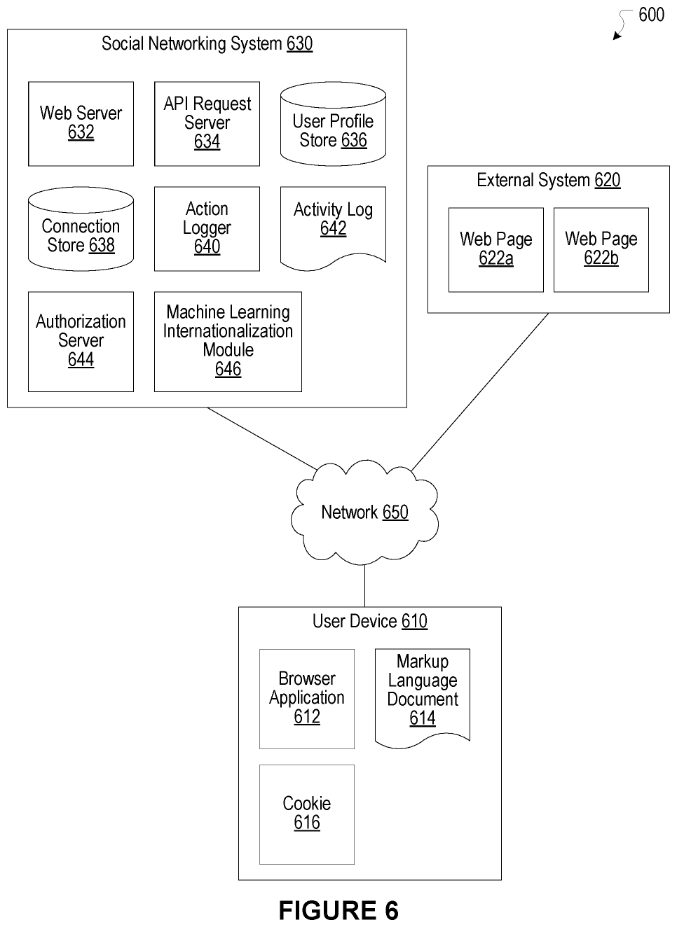

In some embodiments, the machine learning internationalization module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the machine learning internationalization module 102 can be, in part or in whole, implemented as software running on one or more computing devices or systems, such as on a server system or a client computing device. In some instances, the machine learning internationalization module 102 can be, in part or in whole, implemented within or configured to operate in conjunction or be integrated with a social networking system (or service), such as a social networking system 630 of FIG. 6. Likewise, in some instances, the machine learning internationalization module 102 can be, in part or in whole, implemented within or configured to operate in conjunction or be integrated with a client computing device, such as the user device 610 of FIG. 6. For example, the machine learning internationalization module 102 can be implemented as or within a dedicated application (e.g., app), a program, or an applet running on a user computing device or client computing system. The application incorporating or implementing instructions for performing functionality of the machine learning internationalization module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the machine learning internationalization module 102. The data maintained by the data store 120 can include, for example, information relating to machine learning models, languages, training data, content items, classifications, labels, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the machine learning internationalization module 102 can be configured to communicate and/or operate with the data store 120. In some embodiments, the data store 120 can be a data store within a client computing device. In some embodiments, the data store 120 can be a data store of a server system in communication with the client computing device.

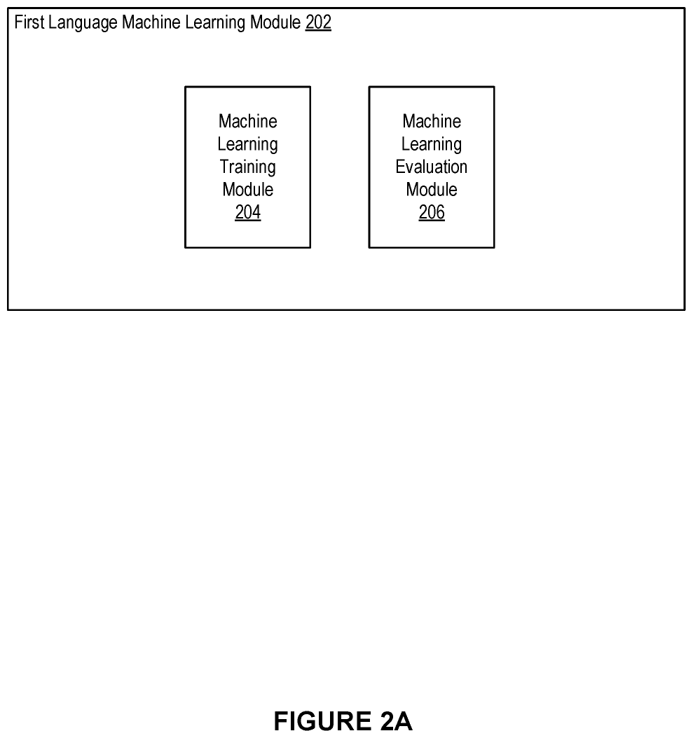

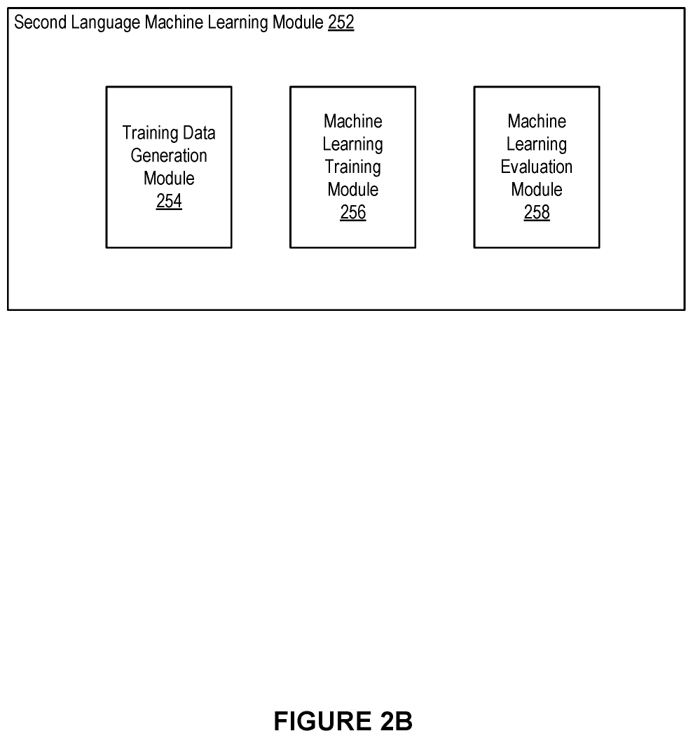

FIG. 2A illustrates an example first language machine learning module 202 configured to train a machine learning model to classify content items in a first language, according to an embodiment of the present technology. In some embodiments, the first language machine learning module 104 of FIG. 1 can be implemented with the example first language machine learning module 202. As shown in the example of FIG. 2A, the example first language machine learning module 202 can include a machine learning training module 204 and a machine learning evaluation module 206.

The machine learning training module 204 can train a machine learning model to determine a classification for a content item in a first language. A classification for a content item can indicate whether the content item is a particular type of content item. Training data for training the machine learning model can include training examples labeled by humans. The training data can include information relating to content items in the first language and corresponding labels for classifications for the content items in the first language. For example, a classification for a content item in the first language in the training data can indicate whether the content item in the first language is a particular type of content item or not. The training data can include various features. For example, features can relate to content attributes, user attributes, comment attributes, sentiment reaction attributes, etc. Content attributes can relate to a content item and can include any attributes associated with content of a content item. Examples of content attributes can include text, an image, a video, an audio, a type of media (e.g., an image, a video, an audio, text, etc.), a subject matter, one or more objects represented in a content item, a duration of a content item (e.g., time length of a video), etc. User attributes can include any attributes associated with users. Users can include authoring users and/or viewing users. An authoring user can refer to a user who creates a content item. A viewing user can refer to a user who views or otherwise consumes a content item. User attributes can relate to any attributes associated with a user of a content item. Examples of user attributes can include a location (e.g., a country, state, county, city, etc.), an age, an age range, a gender, a language, interests (e.g., topics in which a user has expressed interest), a computing device, an operating system (OS) of a computing device, activities, etc. Comment attributes can include any attributes associated with comments created in response to a content item. Sentiment reaction attributes can include any attributes associated with sentiment reactions selected in response to a content item. For example, a content item can be a post, and a user can create a comment and/or select a sentiment reaction in response to the post. Many variations are possible. The machine learning training module 204 can train the machine learning model to generate a score for a classification. The score associated with a classification can reflect a predicted likelihood that a content item in the first language falls within the classification. In some embodiments, the machine learning training module 204 can train the machine learning model to generate scores for a plurality of different classifications. The machine learning training module 204 can retrain the machine learning model based on new or updated training data.

The machine learning evaluation module 206 can apply the trained machine learning model to determine a classification for a content item in the first language. For example, the trained machine learning model can be applied to feature data relating to a content item in the first language to determine a classification for the content item. For example, the trained machine learning model can generate a score for a classification. The score associated with a classification can reflect a predicted likelihood that a content item in the first language falls within the classification. In some instances, the machine learning evaluation module 206 can determine a content item in the first language to fall within the classification if the score for the classification for the content item in the first language satisfies a threshold value. In some instances, the machine learning evaluation module 206 can determine a content item in the first language to not fall within the classification if the score for the classification for the content item in the first language does not satisfy a threshold value.

One or more machine learning models discussed in connection with the machine learning internationalization module 102 and its components, such as the first language machine learning module 202 and the second language machine learning module 252 discussed below, can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

FIG. 2B illustrates an example second language machine learning module 252 configured to train a machine learning model to classify content items in a second language, according to an embodiment of the present technology. In some embodiments, the second language machine learning module 106 of FIG. 1 can be implemented with the example second language machine learning module 252. As shown in the example of FIG. 2B, the example second language machine learning module 252 can include a training data generation module 254, a machine learning training module 256, and a machine learning evaluation module 258.

The training data generation module 254 can generate training data for training a machine learning model for classifying content items in a second language based on a machine learning model for classifying content items in a first language. As discussed herein, a machine learning model for classifying content items in a first language can be referred to as a “first language machine learning model,” and a machine learning model for classifying content items in a second language can be referred to as a “second language machine learning model.” A content item in the first language can be referred to as a “first language content item,” and a content item in the second language can be referred to as a “second language content item.” The first language machine learning model can be trained by the first language machine learning module 202, as discussed herein. The training data generation module 254 can obtain a second language content item and apply machine translation to the second language content item in order to generate a machine translation of the second language content item. For example, machine translation can be performed on text of the second language content item to translate the text from the second language to the first language. The training data generation module 254 can apply the first language machine learning model to the machine translation of the second language content item to determine a classification for the second language content item. The training data generation module 254 can include a set of second language content items and corresponding classifications for the second language content items as determined by the first language machine learning model in training data to train the second language machine learning model. For example, the training data generation module 254 can automatically generate training data that includes a plurality of second language content items and labels corresponding to the classifications for the plurality of second language content items. In some embodiments, a label for a second language content item generated based on the first language machine learning model can be referred to as a “pseudo label” since the label is generated without labeling by humans. The training data can include positive training examples and negative examples. In some embodiments, the training data generated by the training data generation module 254 and training examples in the training data can be verified by human labelers in order to increase accuracy of the second language machine learning model. For example, a trained second language machine learning model can be refined based on the training data verified by human labelers.

The training data generation module 254 can automatically generate training data for training the second language machine learning model since a classification for a second language content item to be included in the training data can be determined based on the first language machine learning model, instead of labeling by humans. The automated generation of training data can reduce an amount of time for preparing and generating training data. The training data generation module 254 can also sample positive training examples more easily, compared to labeling of second language content items by humans. For example, if content items of a particular type are not common, for example, not often created by users, human labelers may have to review a significant number of content items in order to identify positive training examples for that particular type. Applying the first language machine learning model to determine classifications for second language content items to include in the training data can facilitate sampling of positive training examples. For example, second language content items that are determined by the first language machine learning model to fall within a classification can be included in the training data as positive training examples. Accordingly, the training data generation module 254 can generate a higher number or ratio of positive training examples to include in the training data, compared to labeling by humans.

The machine learning training module 256 can train a machine learning model to determine a classification for a content item in a second language based on training data generated by the training data generation module 254. The second language machine learning model can be trained to determine the same classification(s) as the first language machine learning model. For example, a classification for a content item can indicate whether the content item is a particular type of content item, and the first language machine learning model and the second language machine learning model can both determine whether a content item in a respective language is a particular type of content item and falls within the same classification. The training data can include various features. Features included in the training data for the second language machine learning model can be similar to features included in training data for the first language machine learning model. For example, features in the training data for the second language machine learning model can relate to content attributes, user attributes, comment attributes, sentiment attributes, etc., as described in connection with the first language machine learning module 202. The machine learning training module 256 can train the second language machine learning model to generate a score for a classification. The score associated with a classification can reflect a predicted likelihood that a second language content item falls within the classification. In some embodiments, the machine learning training module 256 can train the second language machine learning model to generate scores for a plurality of different classifications. The machine learning training module 256 can retrain the second language machine learning model based on new or updated training data. For example, the machine learning training module 256 can retrain or refine the second language machine learning model when at least a portion of the training data is verified by human labelers.

The machine learning evaluation module 258 can apply the trained second language machine learning model to determine a classification for a second language content item. For example, the trained second language machine learning model can be applied to feature data relating to a second language content item to determine a classification for the second language content item. For example, the trained second language machine learning model can generate a score for a classification. The score associated with a classification can reflect a predicted likelihood that a second language content item falls within the classification. In some instances, the machine learning evaluation module 258 can determine a second language content item to fall within the classification if the score for the classification for the second language content item satisfies a threshold value. In some instances, the machine learning evaluation module 258 can determine a second language content item to not fall within the classification if the score for the classification for the second language content item does not satisfy a threshold value. All examples herein are provided for illustrative purposes, and there can be many variations and other possibilities.

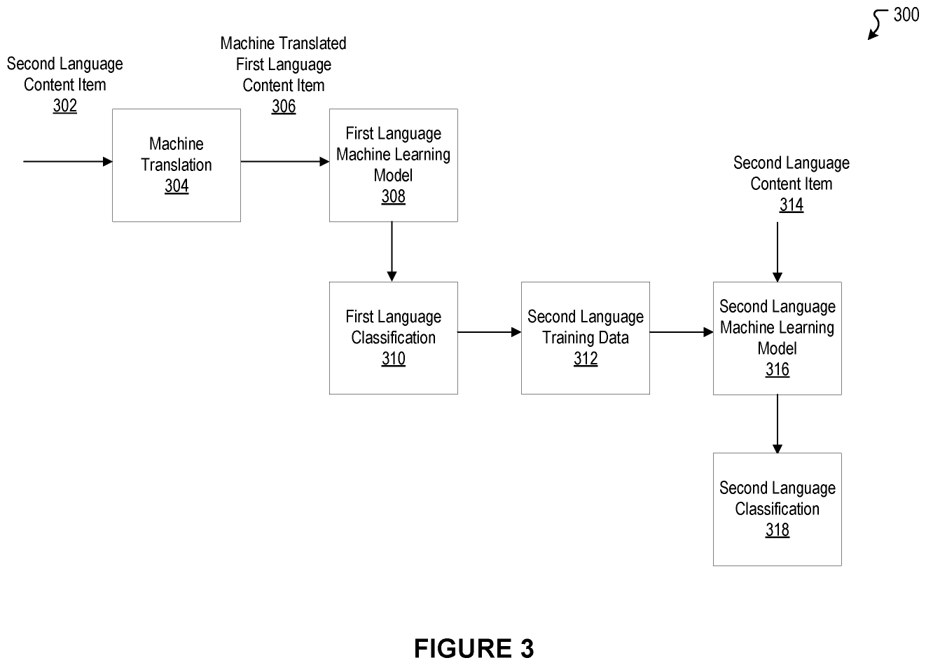

FIG. 3 illustrates an example functional block diagram 300 for training a machine learning model for a second language based on a machine learning model for a first language, according to an embodiment of the present technology. Operations and functionalities associated with the functional block diagram 300 can be performed by the machine learning internationalization module 102, as discussed herein. At block 304, machine translation can be applied to a second language content item 302 in order to generate a machine translated first language content item 306. The machine translated first language content item 306 can be provided as an input to a first language machine learning model 308. The first language machine learning model 308 can output a first language classification for the machine translated first language content item 306, which can be used as a classification for the second language content item 302. The classification can relate to a particular type of content item. The second language content item 302 and the classification determined by the first language machine learning model 308 can be included in second language training data 312 for training a second language machine learning model 316. For example, the second language training data 312 can include a set of second language content items and corresponding classifications determined by the first language machine learning model 308. For example, the second language training data 312 can include positive training examples and negative training examples for a particular type of content item. In a real time process, a second language content item 314 can be provided as an input to the second language machine learning model 316 in order to determine a classification for the second language content item 314. The second language machine learning model 316 can output a second language classification 318 for the second language content item 314. All examples herein are provided for illustrative purposes, and there can be many variations and other possibilities.

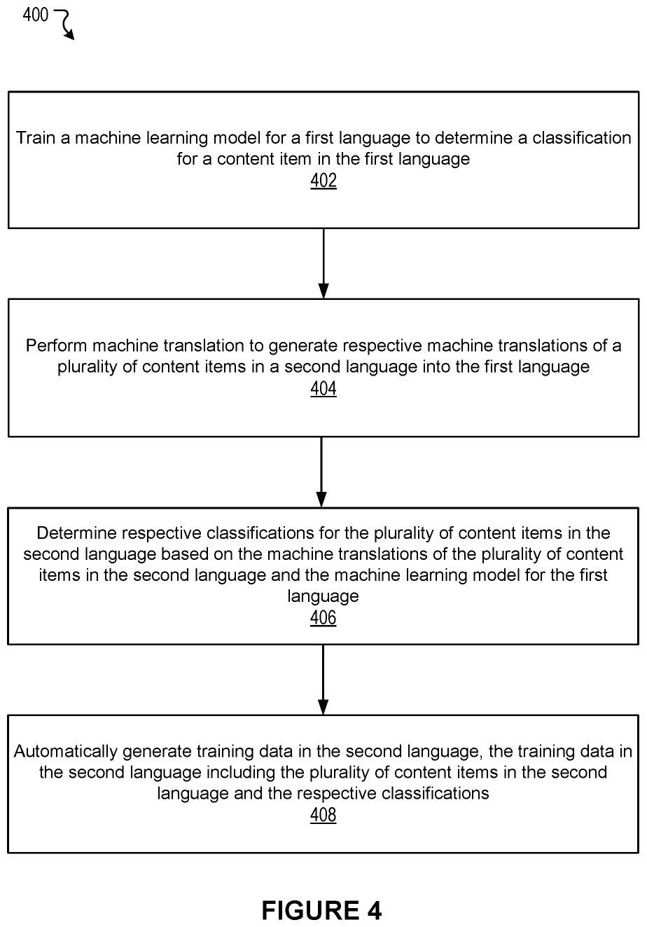

FIG. 4 illustrates an example first method 400 for training a machine learning model for a second language based on a machine learning model for a first language, according to an embodiment of the present technology. It should be understood that there can be additional, fewer, or alternative steps performed in similar or alternative orders, or in parallel, based on the various features and embodiments discussed herein unless otherwise stated.

At block 402, the example method 400 can train a machine learning model for a first language to determine a classification for a content item in the first language. At block 404, the example method 400 can perform machine translation to generate respective machine translations of a plurality of content items in a second language into the first language. At block 406, the example method 400 can determine respective classifications for the plurality of content items in the second language based on the machine translations of the plurality of content items in the second language and the machine learning model for the first language. At block 408, the example method 400 can automatically generate training data in the second language, the training data in the second language including the plurality of content items in the second language and the respective classifications. Other suitable techniques that incorporate various features and embodiments of the present technology are possible.

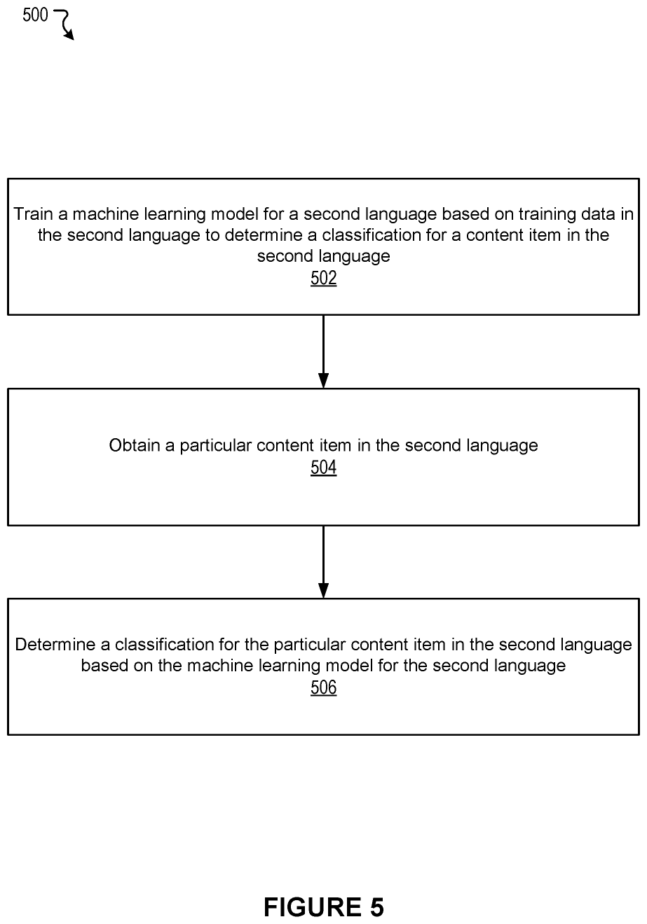

FIG. 5 illustrates an example second method 500 for training a machine learning model for a second language based on a machine learning model for a first language, according to an embodiment of the present technology. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model for a second language based on training data in the second language to determine a classification for a content item in the second language. At block 504, the example method 500 can obtain a particular content item in the second language. At block 506, the example method 500 can determine a classification for the particular content item in the second language based on the machine learning model for the second language. Other suitable techniques that incorporate various features and embodiments of the present technology are possible.

It is contemplated that there can be many other uses, applications, features, possibilities, and/or variations associated with various embodiments of the present technology. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a machine learning internationalization module 646. The machine learning internationalization module 646 can be implemented with the machine learning internationalization module 102, as discussed in more detail herein. In some embodiments, one or more functionalities of the machine learning internationalization module 646 can be implemented in the user device 610.

### Hardware Implementation

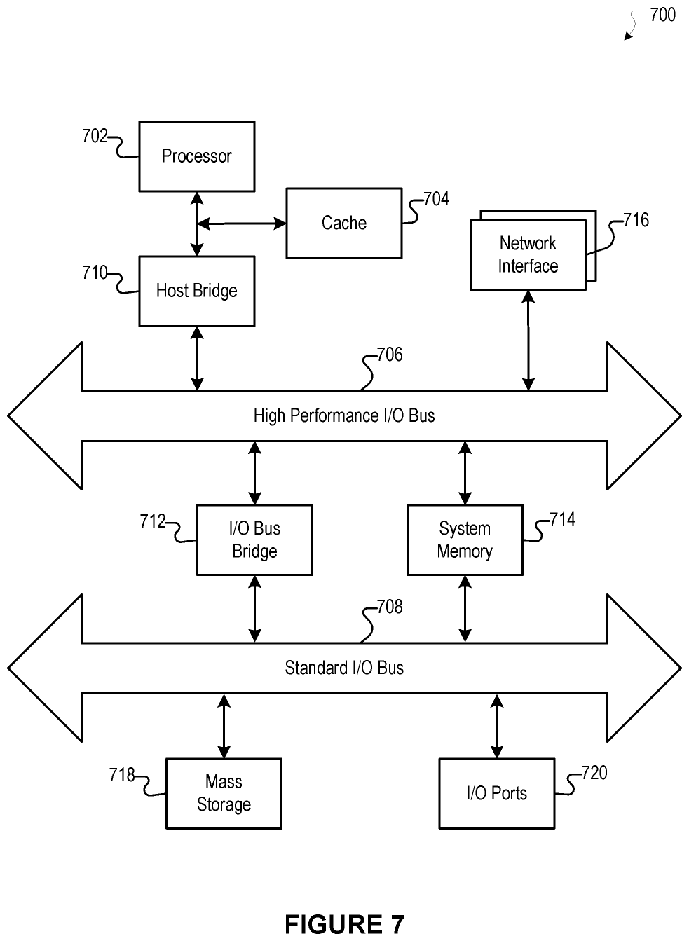

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
providing, by a computing system, a first machine learning model to determine classifications for a first plurality of content items in a first language;
performing, by the computing system, machine translation of a second plurality of content items originally in a second language to generate the second plurality of content items in the first language, classifications for the second plurality of content items to be determined;
in response to performance of machine translation of the second plurality of content items to the first language, determining, by the computing system, based on the first machine learning model, respective classifications for the second plurality of content items in the first language;
generating, by the computing system, training data in the second language to train a second machine learning model to determine a classification for a content item in the second language, the training data in the second language including i) the second plurality of content items in the second language and ii) labels constituting the respective classifications of the second plurality of content items determined by the first machine learning model; and
training, by the computing system, the second machine learning model based on the training data in the second language including i) the second plurality of content items in the second language and ii) labels constituting the respective classifications of the second plurality of content items determined by the first machine learning model after the second plurality of content items were translated from the first language to the second language.

2. The computer-implemented method of claim 1, wherein the first machine learning model is trained based on training data in the first language that includes content items in the first language and their respective classifications.

3. The computer-implemented method of claim 1, wherein the first machine learning model is trained to output scores indicative of a predicted likelihood of the first plurality of content items in the first language being associated with the classifications in the first language.

4. (canceled)

5. The computer-implemented method of claim 1, wherein the second machine learning model is trained to output a score indicative of a predicted likelihood of the content item in the second language being associated with the classification for the content item in the second language.

6. The computer-implemented method of claim 1, further comprising:
obtaining, by the computing system, a particular content item in the second language; and
determining, by the computing system, a classification for the particular content item in the second language based on the second machine learning model.

7. The computer-implemented method of claim 1, further comprising:
refining, by the computing system, the second machine learning model based at least on a verified portion of the training data in the second language.

8. (canceled)

9. The computer-implemented method of claim 1, wherein performing machine translation to the second plurality of content items in the second language to generate the machine translations of the second plurality of content items in the first language includes translating text associated with the second plurality of content items in the second language from the second language into the first language.

10. The computer-implemented method of claim 2, wherein the training data in the first language and the training data in the second language include features relating to one or more of: content attributes, user attributes, comment attributes, or reaction attributes.

11. A system comprising:
at least one hardware processor; and
a memory storing instructions that, when executed by the at least one processor, cause the system to perform:
providing a first machine learning model to determine classifications for a first plurality of content items in a first language;
performing machine translation of a second plurality of content items originally in a second language to generate the second plurality of content items in the first language, classifications for the second plurality of content items to be determined;
in response to performance of machine translation of the second plurality of content items to the first language, determining, based on the first machine learning model, respective classifications for the second plurality of content items in the first language;
generating training data in the second language to train a second machine learning model to determine a classification for a content item in the second language, the training data in the second language including i) the second plurality of content items in the second language and ii) labels constituting the respective classifications of the second plurality of content items determined by the first machine learning model; and
training the second machine learning model based on the training data in the second language including i) the second plurality of content items in the second language and ii) labels constituting the respective classifications of the second plurality of content items determined by the first machine learning model after the second plurality of content items were translated from the first language to the second language.

12. The system of claim 11, wherein the instructions, when executed, further cause the system to perform:
training the second machine learning model based on the training data in the second language to determine a classification for a content item in the second language.

13. The system of claim 12, wherein the second machine learning model is trained to output a score indicative of a predicted likelihood of the content item in the second language being associated with the classification for the content item in the second language.

14. The system of claim 12, wherein the instructions, when executed, further cause the system to perform:
obtaining a particular content item in the second language; and
determining a classification for the particular content item in the second language based on the second machine learning model.

15. The system of claim 12, wherein the instructions, when executed, further cause the system to perform:
refining the second machine learning model based at least on a verified portion of the training data in the second language.

16. A non-transitory computer readable medium including instructions that, when executed by at least one hardware processor of a computing system, cause the computing system to perform a method comprising:
providing a first machine learning model to determine classifications for a first plurality of content items in a first language;
performing machine translation of a second plurality of content items originally in a second language to generate the second plurality of content items in the first language, classifications for the second plurality of content items to be determined;
in response to performance of machine translation of the second plurality of content items to the first language, determining, based on the first machine learning model, respective classifications for the second plurality of content items in the first language;
generating training data in the second language to train a second machine learning model to determine a classification for a content item in the second language, the training data in the second language including i) the second plurality of content items in the second language and ii) labels constituting the respective classifications of the second plurality of content items determined by the first machine learning model; and
training the second machine learning model based on the training data in the second language including i) the second plurality of content items in the second language and ii) labels constituting the respective classifications of the second plurality of content items determined by the first machine learning model after the second plurality of content items were translated from the first language to the second language.

17. The non-transitory computer readable medium of claim 16, wherein the instructions, when executed, further cause the computing system to perform:
training the second machine learning model based on the training data in the second language to determine a classification for a content item in the second language.

18. The non-transitory computer readable medium of claim 17, wherein the second machine learning model is trained to output a score indicative of a predicted likelihood of the content item in the second language being associated with the classification for the content item in the second language.

19. The non-transitory computer readable medium of claim 17, wherein the instructions, when executed, further cause the computing system to perform:
obtaining a particular content item in the second language; and
determining a classification for the particular content item in the second language based on the second machine learning model.

20. The non-transitory computer readable medium of claim 17, wherein the instructions, when executed, further cause the computing system to perform:
refining the second machine learning model based at least on a verified portion of the training data in the second language.

21. The computer-implemented method of claim 1, wherein the training data for the first machine learning model includes training examples labeled by humans.

22. The computer-implemented method of claim 1, wherein the training data for the second machine learning model is generated without human labeling.
